(19) United States
(12) Patent Application Publication
(10) Pub. No.: US 2019/0308803 A1
(43) Pub. Date: Oct. 10, 2019

(54) AN ELONGATED PACKAGE FOR A WINDSCREEN WIPER DEVICE OF THE FLAT BLADE TYPE

(71) Applicant: FEDERAL-MOGUL S.A., AUBANGE (BE)

(72) Inventor: ALEXANDRE ROSIERE, BASTOGNE (BE)

(21) Appl. No.: 16/309,614

(22) PCT Filed: Jun. 20, 2016
(86) PCT No.: PCT/EP2016/064216

§ 371 Date: Dec. 13, 2018

(51) Int. Cl. B65D 85/68; B65D 75/06; B65D 75/52; B65D 75/56

(52) U.S. Cl. CPC B65D 85/68; B65D 75/06; B60S 1/3848; B65D 75/566; B65D 75/527

(57) ABSTRACT

An elongated package for a windscreen wiper device of the flat blade type two sleeves being interconnected along their length, wherein each sleeve is arranged to hold a windscreen wiper device of the flat blade type, wherein walls of each sleeve enclose an acute angle.

### BACKGROUND

### Technical Field

The present invention relates to an elongated package for a windscreen wiper device of the flat blade type.

The present invention also relates to a system comprising such an elongated package according to the invention, as well as two windscreen wiper devices of the flat blade type packaged therein.

### Related Art

A windscreen Wiper device of the flat blade type comprises an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, wherein ends of the wiper blade and/or of the longitudinal strip may be connected with a respective connecting piece, the carrier element biasing the wiper blade in a curved position, which windscreen wiper device comprises a connecting device for pivot ally connecting an oscillating wiper arm thereto near one end thereof. The longitudinal strip is usually referred to as a flexor, whereas the connecting piece is usually indicated as an end cap. The connecting device in practice is referred to as a connector. the wiper blade is preferably made by extrusion. Hence, the present windscreen wiper device is designed as a so-called “yokeless” wiper device, wherein use is no longer made of several yokes pivotally connected to each other, but wherein the wiper blade is biased by the carrier element, as a result of which it exhibits a specific curvature.

It is noted that the present invention is not restricted to the use of only one longitudinal strip forming the elastic carrier that is particularly located in a central longitudinal groove of the wiper blade. Instead, the carrier may also comprise two longitudinal strips, wherein the strips are disposed in opposite longitudinal grooves of the wiper blade, the groove(s) may be closed at one outer end.

Further, it is noted that in practice use is made of a mounting head fixed for rotation to a shaft, wherein the shaft is rotatable alternately in a clockwise and in a counter-clockwise sense carrying the mounting head into rotation. Thus, in turn the mounting head draws the connecting device into rotation and thereby moves the wiper blade. In the alternative, the mounting head is fixed for translation to a carriage, wherein the carriage can be translated alternately in a one linear direction and in another counter linear direction carrying the mounting head into translation. The present windscreen wiper device can therefore he used circular or linear movement of the mounting head.

Such an elongated package is generally known.

One drawback of this known package is the fact that due its specific curvature the windscreen Wiper device thereof cannot be inserted easily in the package, whereas once the windscreen wiper device is taken out the package it cannot be handled easily, for example in an outlet for display purposes. A further disadvantage is that it is expensive and cumbersome to make use of two packages for packaging two windscreen wiper devices with wiper blades having different lengths for a car.

### SUMMARY

The object of the invention is to overcome the drawbacks of the prior art as mentioned above, in particular to make it possible that the windscreen wiper device can be efficiently held during transport, storage and display.

In order to accomplish that objective, an elongated package of the kind referred to in the introduction is characterized according to the invention in that the package comprises two sleeves being interconnected along their length, wherein each sleeve is arranged to hold a windscreen wiper device of the flat blade type, wherein walls of each sleeve enclose an acute angle, the angle is preferably smaller than or equal to 45°. Thus, the sleeves are each shaped such that a windscreen wiper device of the flat blade packed therein is supported along its connecting device and/or its longitudinal strips and/or its connecting pieces, while a wiping lip thereof rests free inside towards a vertex of the respective sleeve (i.e. is not engaged by the walls of the respective sleeve). Thus, the present invention avoids that the wiping lip is in contact with its corresponding sleeve. The present package allows packaging two windscreen wiper devices in the sleeves, so that particularly two windscreen wiper devices with wiper blades having different lengths for one car can be efficiently transported, stored and displayed in one package. Further, as the sleeves each have walls enclosing an acute angle preferably smaller than or equal to 45°, the windscreen wiper devices are supported inside the chambers at the location of their connecting devices and/or the connecting pieces, for example, without damaging a longitudinal wiping lip of the wiper blade thereof. Thus, the wiping lip is not engaged by the package and rests free inside the package. Wiping properties are therefore not negatively affected h using the package for transport, storage and display.

Particularly, the sleeves are interconnected along their entire length.

The package is preferably made from one blank.

It is noted that the present elongated package enveloping the two windscreen wiper devices is used without any further packages, so that the present package solely acts as holder during transport, storage and/or display.

In one preferred embodiment of an elongated package in accordance with the invention the walls enclosing the acute angle are facing towards the interconnection of the sleeves. In the alternative, the walls enclosing the acute angle are facing away from the interconnection of the sleeves.

In another preferred embodiment of an elongated package according to the invention the package is mirror symmetrical relative to a vertical median plane thereof. Hence, in both sleeves the walls enclosing the acute angle are facing towards the interconnection of the sleeves or facing away from the interconnection of the sleeves. In the alternative, the package is non-mirror symmetrical relative to a vertical median plane thereof. Thus, in one sleeve the walls enclosing the acute angle are facing towards the interconnection of the sleeves, whereas in the other sleeve the walls enclosing the acute angle are facing away from the interconnection or the sleeves.

In another preferred embodiment of an elongated package in accordance with the invention the walls enclose an acute angle smaller than 40°, preferably smaller than more preferably smaller than 30°.

In another preferred embodiment of an elongated package according to the invention the package comprises a weakening line at the location of the interconnection of the sleeves, the sleeves can thus be easily separated from each other by hand.

In another preferred embodiment of an elongated package in accordance with the invention the sleeves are bend towards each other, wherein the sleeves are interconnected along walls thereof. A more compact package is thus obtained for efficient transport,

The package according, to the invention particularly comprises a suspension hole to enable storing the package in vertical (suspended/banging) position, the sleeves are preferably printed or labelled in order to indicate applications of the packaged wiper blades and/or to contain advertising.

As indicated, the present invention also refers to a system comprising an elongated package according, to the present invention, as well as two windscreen wiper devices of the flat blade type, wherein one windscreen wiper device thereof is held by one of the sleeves, and wherein the other windscreen wiper device thereof is held by the other of the sleeves. Particularly, a wiping lip of each windscreen wiper device of the flat blade type is facing towards the acute angle.

The invention will now be explained in more detail with reference to Figures illustrated in a drawing, wherein:

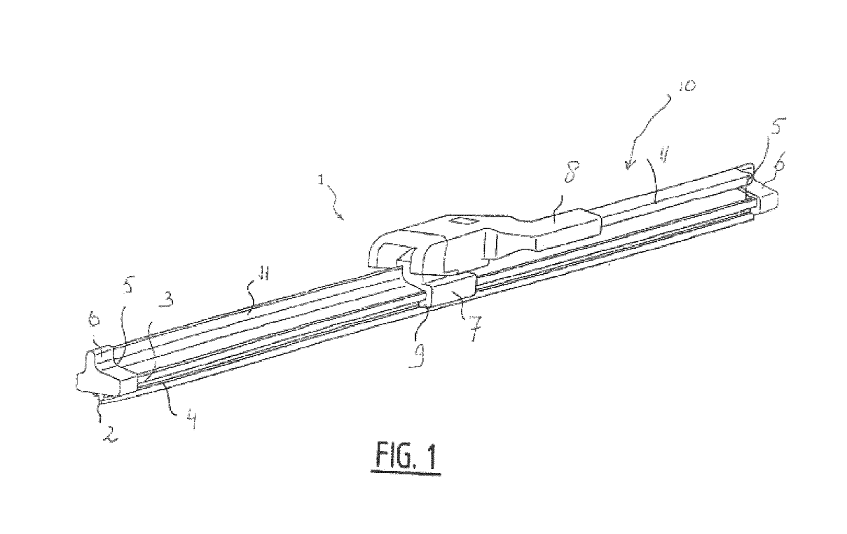

FIG. 1 is a total perspective, schematic view of a windscreen wiper device of the flat blade type to be packaged in a package according to the invention;

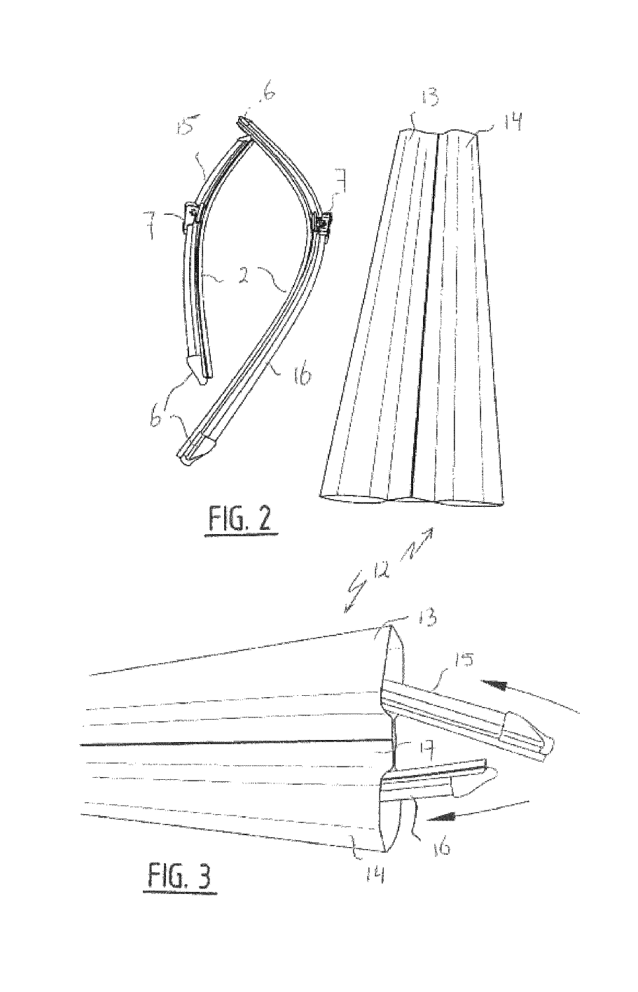

FIG. 2 is a perspective, schematic view of a preferred embodiment of a sleeves-like package in accordance with the invention, together with two windscreen wiper devices of the flat blade type ready to be packaged;

FIG. 3 corresponds to FIG. 2, but now sliding the windscreen wiper devices inside the package

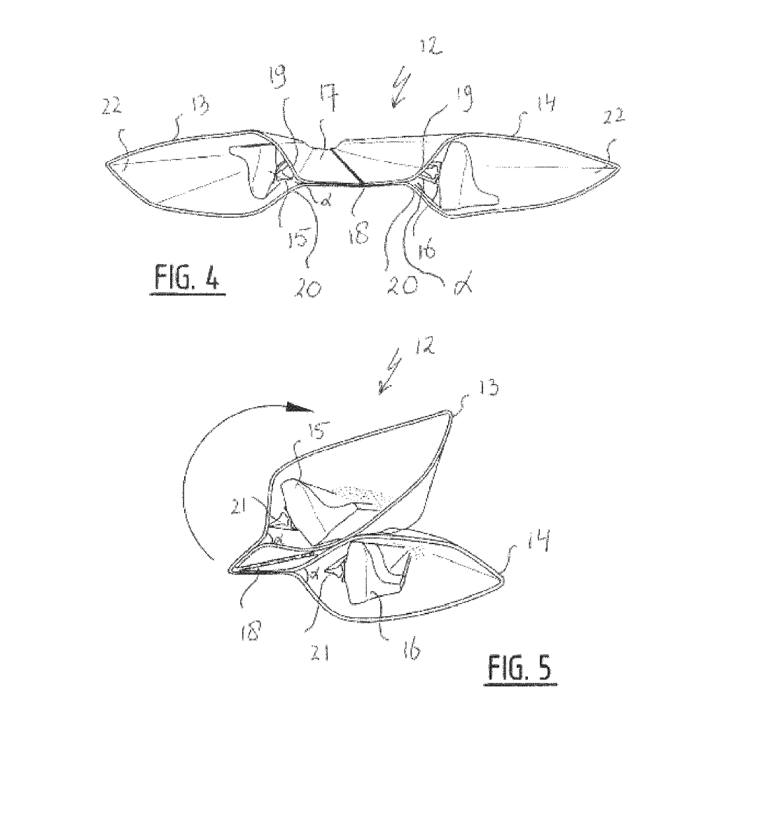

FIG. 4 corresponds to FIG. 3, but now the windscreen wiper devices being packaged;

FIG. 5 corresponds to FIG. 4, on the understanding that the sleeves are bend towards each other and interconnected; and

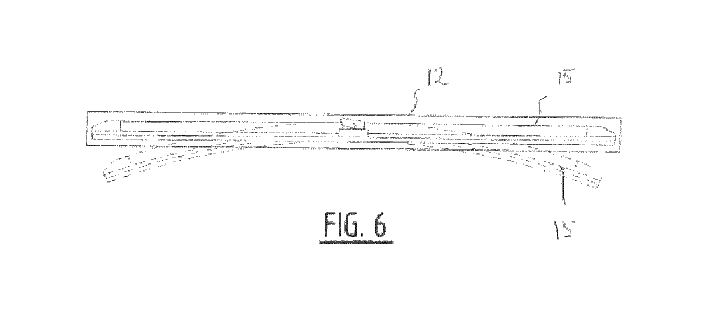

FIG. 6 is a schematic side view of the package of FIG. 4 showing that the packaged windscreen wiper devices are straightened inside the package.

### DETAILED DESCRIPTION

FIG. 1 shows a preferred variant of a windscreen wiper device 1 of the flat blade type. The windscreen wiper device is built up of an elastomeric wiper blade 2, in the longitudinal sides of which opposing longitudinal grooves 3 are formed, and of longitudinal Strips 4 made of spring band steel, which are fitted in the longitudinal grooves 3, the strips 4 firm a flexible carrier element for the rubber wiper blade 2, as it were, which is thus biased in a curved position (the curvature in operative position being that of a windscreen to be wiped). Neighbouring ends 5 of strips 4 are interconnected on either side of the windscreen wiper device I by means of connecting pieces 6 or end caps functioning as clamping members. In this embodiment, the connecting pieces 6 are separate constructional elements, which may be form-locked as well as force-locked to the strips 4 made of spring band steel, in the latter case the connecting pieces form transverse bridges for the strips 4, as it were. The windscreen wiper device 1 is furthermore built up of a connecting device 7 of plastic or metallic material for an oscillating wiper arm 8. Connecting device 7 comprises clamping members 9 that are integral therewith, which engage round longitudinal sides of the strips 4 that face away from each other, as a result of which the connecting device 7 is firmly attached to the unit consisting or wiper blade 2 and strips 4. The oscillating wiper arm 8 is pivotally connected to the connecting device 7 about a pivot axis near one end. A spoiler or “air deflector” 10 is included and comprises two separate sub-spoilers 11. Each sub-spoiler is detachably connected in its entirety to the wiper blade 2 on opposite sides of the connecting device 7.

In FIG. 2 an elongated package 12 in the form of two interconnected sleeves 13, 14 is depicted. Each sleeve 13, 14 is arranged to receive and accommodate a windscreen wiper device 15, 16 of the flat blade type. This is shown in FIG. 3, wherein these windscreen wiper devices 1 5, 16 are slid in longitudinal direction inside their corresponding sleeves 3, 14. In FIG. 3 the wiper blades are represented with their wiping lips directed towards the center of the package 12, but in another preferred embodiment their wiping lips are directed away from the center, i.e. to the outside of the package. The package 12 is made from one blank and is made entirely of cardboard. As shown in FIGS. 3 and 4, the package 12 is manufactured by interconnecting an upper surface and a bottom surface of one bigger sleeve together along their length and along a portion of their width, for example by local hot melting or gluing, so that an interconnection region 17 is formed. The interconnecting region 17 may he provided by a weakening line, particularly a perforation line 18, to easily separate the sleeves 13, 14 by hand through a tearing operation.

With reference to FIG. 4, walls 19, 20 of each sleeve 13, 14 that face towards the interconnection region 17 of the sleeves 13, 14 enclose an acute angle a smaller than 45°.

Hence, the windscreen wiper devices 15,16 are supported inside their corresponding sleeves 13,14 at the location of its connecting device 7 and/or its connecting pieces 6, and so that a wiping lip 21 of the wiper blade 2 thereof is not engaged at all. The wiping lip 21 rests thus free inside the sleeves 13, 14 and cannot he damaged during transport, for example. As shown, the package 12 is mirror symmetrical relative to a vertical median plane perpendicular to the interconnection region 17 thereof. This is also the case in another preferred embodiment (not shown), wherein the walls 19,20 enclosing the acute angle a face away from the interconnection region 17 of the sleeves 13,14, i.e. at the location 22, the package 12 is non-mirror symmetrical relative to the vertical median plane thereof in case one of the sleeves 13 has the acute angle α towards the interconnection region 17 and the other of the sleeves 14 has the acute angle α away from the interconnection region 17, that is at the location 22.

In FIG. 5 the sleeves 13, 14 are bend towards each other and are subsequently connected together, for example glued.

As shown in FIG. 6, the windscreen wiper devices 15,16 are stretched, i.e. straightened inside their corresponding sleeves 13,14, seen relative to their curved position prior to insertion in the package in FIG. 2 (shown in dotted lined in FIG. 6).

The present invention is not restricted to the embodiment shown, but also covers other preferred embodiments falling under the scope of the appended claims.

1. An elongated package for a windscreen wiper device of the flat blade type, comprising two sleeves being interconnected along their length, wherein each sleeve is arranged to hold a windscreen wiper device of the flat blade type, wherein walls of each sleeve enclose an acute angle a.

2. The elongated package according to claim 1, wherein said walls enclosing said acute angle are facing towards the interconnection of said sleeves.

3. The elongated package according to claim 1, wherein said walls enclosing said acute angle are facing away from the interconnection of said sleeves.

4. The elongated package according to claim 1, wherein said package is mirror symmetrical relative to a vertical median plane thereof.

5. The elongated package according to claim 1, wherein said package is non-mirror symmetrical relative to a vertical median plane thereof.

6. The elongated package according to claim 1, wherein said walls enclose an acute angle α smaller than or equal to 45°.

7. The elongated package according to claim 6, wherein said walls enclose an acute angle a smaller than 35°.

8. The elongated package according to claim 6, wherein said walls enclose an acute angle a smaller than 30°.

9. The elongated package according to claim 1, wherein said package is made from one blank.

10. The elongated package according to claim 1, wherein said package comprises a weakening line at the location of the interconnection

11. The elongated package according to claim 1, wherein said sleeves are bend towards each other, and wherein said sleeves arc interconnected along walls thereof.

12. The elongated package according to claim 1, wherein said package comprises a suspension hole in order to allow storage of said package in suspended, vertical position.

13. A system comprising a package according to claim 1, as well as two windscreen wiper devices of the flat blade type, wherein one windscreen wiper device thereof is held by one of said sleeves, and wherein the other windscreen wiper device thereof is held by the other of said sleeves.

14. A system according to claim 13, wherein a wiping lip of each windscreen wiper device of the flat blade type is facing towards said acute angle a.

15. The elongated package according to claim 6, wherein the acute angle is less than 40°.
